(19) United States
(12) Patent Application Publication
(10) Pub. No.: US 2013/0036213 A1
(43) Pub. Date: Feb. 7, 2013

(54) VIRTUAL PRIVATE CLOUDS

(71) Applicants: MASUM HASAN, Cupertino, CA (US); SUMIT A. NAIKSATAM, Sunnyvale, CA (US); GLENN DASMALCHI, Half Moon Bay, CA (US); KRISHNA SANKAR, San Jose, CA (US); VAUGHN SUAZO, Oklahoma City, OK (US)

(72) Inventors: MASUM HASAN, Cupertino, CA (US); SUMIT A. NAIKSATAM, Sunnyvale, CA (US); GLENN DASMALCHI, Half Moon Bay, CA (US); KRISHNA SANKAR, San Jose, CA (US); VAUGHN SUAZO, Oklahoma City, OK (US)

(21) Appl. No.: 13/196,759

(22) Filed: Aug. 2, 2011

(51) Int. Cl. G06F 15/16

(52) U.S. Cl. 709/223

(57) ABSTRACT

Techniques are described for providing a virtual private cloud in a multi-tenant environment. Embodiments receive a request specifying cloud-based computing resources hosted by one or more cloud providers to integrate into a virtual private cloud with enterprise computing resources, the resources within the virtual private cloud are communicatively coupled at a common logical network level. Embodiments provision a cloud network device to integrate the cloud-based computing resources into the virtual private cloud. Additionally, the enterprise network device is configured to associate the enterprise computing resources with the virtual private cloud. Network packets between applications running on the enterprise computing resources and applications running on the cloud-based computing resources are then forwarded over the common logical network.

### TECHNICAL FIELD

Embodiments presented in this disclosure generally relate to providing access to virtualized computing resources, and more particularly, to seamlessly integrating client resources and cloud resources to form a virtual private cloud.

### BACKGROUND

Server virtualization technology allows multiple virtual machines to run concurrently on a single physical computing system. Currently, data center environments are used to create large clusters of such physical computing systems (commonly referred to as servers), where each server runs multiple virtual machines (VMs). This approach has led to data centers that can supply massive amounts of computing power. Several providers currently allow users to supply virtual machine instances to run on the virtualization servers provided by the operator of the data center. In various forms, this general model of computing has come to be referred to as “cloud computing” or “Infrastructure as a Service” (IaaS) because users simply run their virtual machine instances on an abstract hardware platform, without having to own or manage that hardware platform. This approach allows a given user to rapidly scale up dozens, if not hundreds or thousands of virtual machine instances to respond to changes in demand for computing resources.

As such, cloud computing has become a popular approach for obtaining access to (sometimes large-scale) computing resources. Cloud computing allows users to build virtualized data centers which include compute, networking, application, and storage resources without having to build or maintain a physical computing infrastructure. The virtualized data center may provide a user with a segmented virtual network located in the cloud, typically alongside virtualized data centers of other users. Such a virtualized data center may be rapidly scaled up (or down) according to the computing needs of a given user without the need to maintain excess computing capacity between peak demand periods. For example, an online retailer can scale a virtualized data center to meet increased demand during the holiday shopping season without having to maintain the underlying physical computing infrastructure used to provide the retailer's online presence.

A significant obstacle for such virtualized data centers is that the virtualized resources are not fully integrated with the other resources of the user. For example, a user may maintain numerous software and hardware resources which are external to the cloud and which are interconnected via a first local area network (LAN). Likewise, the user may create a virtualized data center with numerous software and hardware resources in a cloud, with the cloud resources being interconnected via a second LAN. However, the external resources may be unable to communicate with the cloud resources in the virtualized data center because the two sets of resources are each on separate intranetworks. Furthermore, while certain techniques (e.g., port forwarding) may be used to manually connect services from the first LAN to the second LAN, these techniques oftentimes are manually configured, which is frequently a slow and error-prone process. Additionally, such techniques may introduce insecurity into the network environment unless they are carefully and narrowly implemented.

### BRIEF DESCRIPTION OF THE DRAWINGS

So that the manner in which the above-recited features of the present disclosure can be understood in detail, a more particular description of the disclosure briefly summarized above may be had by reference to embodiments, some of which are illustrated in the appended drawings. It is to be noted, however, that the appended drawings illustrate only typical embodiments and are therefore not to be considered limiting of its scope, for the disclosure may admit to other equally effective embodiments.

FIG. 1 is block diagram illustrating a network environment configured to host a virtual private cloud, according to one embodiment presented in this disclosure.

FIG. 2 is a block diagram illustrating a virtual private cloud, according to one embodiment presented in this disclosure.

FIG. 3 is a block diagram illustrating a network environment configured to host multiple virtual private clouds, according to one embodiment presented in this disclosure.

FIG. 4 is a flow diagram illustrating a method for creating a virtual private cloud, according to one embodiment presented in this disclosure.

FIG. 5 is a flow diagram illustrating a method for creating a virtual private cloud, according to one embodiment presented in this disclosure.

FIG. 6 is a block diagram illustrating a network environment configured to a virtual private cloud, according to one embodiment presented in this disclosure.

### DESCRIPTION

### Overview

One embodiment presented herein provides a method for providing a virtual private cloud. The method includes receiving a request to integrate enterprise computing resources with cloud-based computing resources in a virtual private cloud. Generally, the resources within the virtual private cloud are communicatively coupled at a common logical network level. Additionally, the method includes, responsive to the request, issuing one or more network communications to a cloud provider hosting the cloud-based computing resources, wherein the one or more network communications configure the cloud provider to provision a cloud-based network device to forward network packets addressed to network addresses from any of a specified plurality of network addresses between the enterprise computing resources and the cloud-based computing resources. The method also includes integrating the enterprise computing resources into the virtual private cloud by configuring the enterprise network device to forward network packets addressed to network addresses from any of the specified plurality of network addresses between the enterprise computing resources and the cloud-based computing resources, wherein the enterprise network device is configured to send network packets received from enterprise computing resources and sent to network addresses associated with the cloud-based computing resources to the cloud-based network device, and to send network packets received from the cloud-based network device to corresponding enterprise computing resources. In addition, the method includes forwarding network packets between applications running on the enterprise computing resources and applications running on the cloud-based computing resources over the common logical network provided by the virtual private cloud.

Additional embodiments include software embodied in a computer readable medium storing a program configured to perform the aforementioned method, and a system having a processor and a memory storing a program configured to perform the aforementioned method.

Still other embodiments provide a method for instantiating a virtual private cloud containing cloud resources and client resources. The method includes receiving a request specifying cloud resources to be included in the virtual private cloud. Furthermore, the method includes provisioning the cloud resources specified in the request. In addition, the method includes configuring at least one cloud network device to associate the cloud resources with the virtual private cloud. As a result, applications running on the cloud resources are able to interact with applications running on the client resources on a common logical network level.

### Description of Example Embodiments

Embodiments relate to creating an enterprise and service provider class virtual private cloud (“ES-VPC”, which also may be referred to herein as “VPC” for short). Generally, a virtual private cloud is an abstraction which connects client computing resources (also referred to herein as “enterprise resources”) and cloud computing resources as if they were connected via an intranetwork. That is, applications on the client computing resources may treat applications on the cloud computing resources as if they were connected via the same intranetwork (e.g., initiating connections directly to them using local IP addresses), even though the client resources and cloud resources are physically connected to different intranets and in different locations. Examples of computing resources include, without limitation, processing resources, storage resources, network resources and software resources. The client computing resources represent any computing resources maintained by a client entity and may reside at a single client site or across multiple client sites. The cloud computing resources may be hosted using one or more of a plurality of multi-tenant data centers. The term “data center” generally refers to a location which may host cloud services. Moreover, a multi-tenant data center is one which provides (or is capable of providing) segregated cloud resources assigned to multiple virtual private clouds for multiple client entities. As such, a multi-tenant data center may be used to provide separate virtual private clouds for different clients.

Embodiments described herein may be provided to end users through a cloud computing infrastructure. Cloud computing generally refers to the provision of segmented hardware and software resources as a service delivered over a network. More formally, cloud computing may provide an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can typically access any of the resources that reside in the cloud at any time, and from anywhere across the Internet. In context of the present disclosure, users may submit a request to a cloud management system specifying cloud resources for inclusion in a virtual private cloud. As described in greater detail below, a cloud automation component may provision and configure cloud computing resources for inclusion in the enterprise and service provider-class virtual private cloud and may further configure cloud network devices to associate the specified cloud resources with the virtual private cloud. Likewise, an enterprise automation component may perform similar configuration for an enterprise network device to associate enterprise resources with the ES-VPC. Upon instantiation of the virtual private cloud, applications running on the cloud computing resources may communicate with applications running on enterprise computing resources (and vice versa) as if the computing resources were connected to the same intranetwork. In other words, applications running on the cloud resources can interact with applications running on the client resources on a common logical network level. Advantageously, this allows cloud resources to seamlessly and transparently access services provide on the enterprise network (and vice versa).

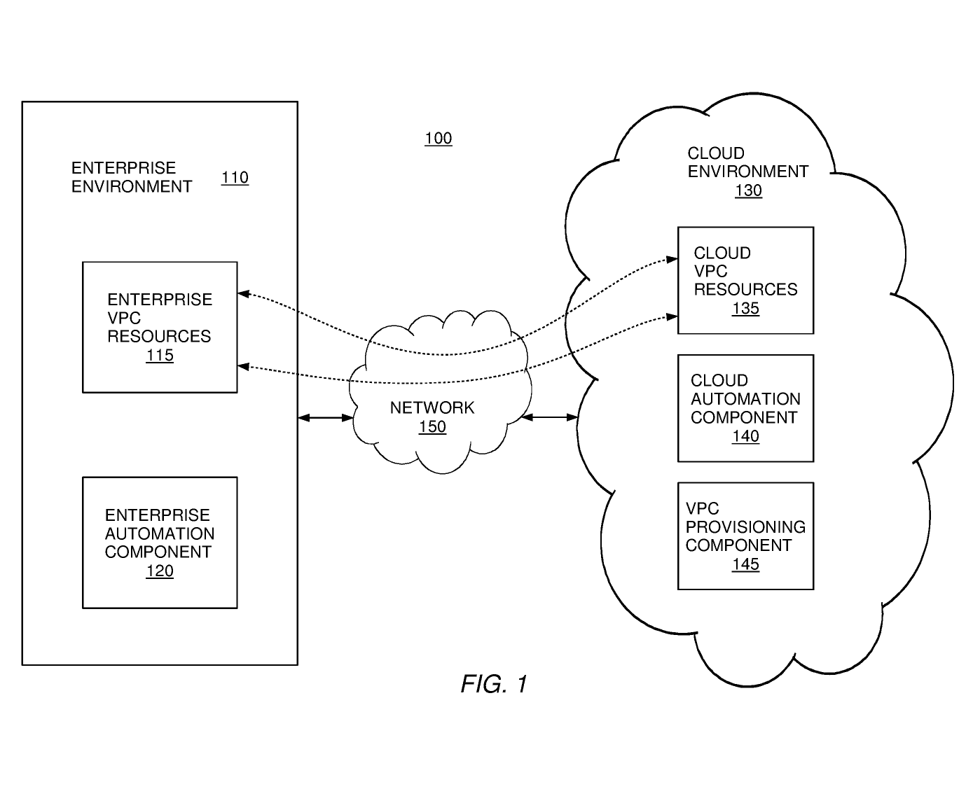

FIG. 1 shows an example of a network environment configured to host a virtual private cloud, according to one embodiment of the present disclosure. As shown, the network environment 100 includes an enterprise environment and a cloud environment connected via a network 150. Of note, for purposes of the present example, assume that both the enterprise environment 110 and the cloud environment 130 maintain an intranetwork by which their respective resources are interconnected. Furthermore, the network 150 in the present example represents an internetwork (e.g., the Internet). As will be discussed in more detail below, embodiments may associate resources from the enterprise environment 110 with resources from the cloud environment 130 together in an enterprise and service provider-class virtual private cloud, such that the resources may communicate with one another as if connected via a single intranetwork.

As shown, the enterprise environment 110 includes enterprise VPC resources 115 and an enterprise automation component 120. Likewise, the cloud environment 130 includes cloud VPC resources 135, a cloud automation component 140 and a VPC provisioning component 145. The enterprise VPC resources 115 represent a set of hardware and software resources managed by the enterprise that have been associated with a virtual private cloud (i.e., by the enterprise automation component 120). Likewise, the cloud VPC resources 135 represent hardware and software resources managed by the cloud provider and that have been associated with the virtual private cloud (e.g., by the cloud automation component 140).

The VPC provisioning component 145 is generally configured to instantiate or otherwise provide cloud resources within a virtual private cloud. For instance, the VPC provisioning component 145 could receive a request (e.g., from the enterprise automation component 120) specifying a collection of cloud resources to include in a virtual private cloud. As an example, a particular request could request 5 virtual machines, each having a specified amount of processing memory and processing capacity. Such a request could further specify parameters for use in configuring the cloud resources. Thus, continuing this example, the request could also specify a range of IP addresses to allocate to the virtual machines. In response, the VPC provisioning component 145 could instantiate the virtual machines (e.g., using cloud resources at one or more data centers) and configure the virtual machines to each be assigned one of the IP addresses from the specified range.

In one embodiment, the enterprise automation component 120 is configured to identify configuration information for the enterprise VPC resources 115. For example, the enterprise automation component 120 could determine that the enterprise VPC resources 115 are currently configured to use Internet Protocol Security (“IPsec”) as the network security protocol. Upon determining this, the enterprise automation component 120 could transmit the configuration information to the VPC provisioning component 145 (e.g., in the request specifying the cloud resources to include in the virtual private cloud). The VPC provisioning component 145 could then use this configuration information to configure the cloud VPC resources 135. Thus, the VPC provisioning component 145 could configure the cloud VPC resources 135 to use the IPsec network security protocol and could configure the network security settings for the cloud based resources to mirror the configuration of the enterprise VPC resources 115. Advantageously, doing so enables the cloud VPC resources 135 to be automatically configured using the same configuration settings as the enterprise VPC resources 115, which results in a more efficient configuration process.

The enterprise automation component 120 generally configures network devices within the enterprise environment 110 to associate particular enterprise resources (i.e., the enterprise VPC resources 115) with the virtual private cloud. In one embodiment, the enterprise automation component 120 configures the enterprise network devices in order to associate all of the enterprise resources within the enterprise environment 110 with the VPC. In other embodiments, enterprise automation component 120 configures the enterprise network devices such that only a select set of enterprise resources are associated with the VPC. For example, the enterprise automation component 120 could configure an enterprise edge router to associate enterprise resources within a particular IP address range with the virtual private cloud. For example, this set of enterprise resources could be specified by a user interacting with a user interface of the enterprise automation component 120.

Generally, the enterprise automation component 120 associates resources with a virtual private cloud by configuring the enterprise network devices to forward network messages to certain network addresses associated with the VPC to a cloud network device. As an example, the enterprise automation component 120 could configure the enterprise edge router to forward network messages sent to a particular range of network addresses to a cloud edge router. Typically, such a range of network addresses corresponds to the network addresses assigned to the cloud resources. For example, if the cloud resources were assigned IP addresses in the range of 10.0.0.1 through 10.0.0.50, the enterprise automation component 120 could configure the enterprise edge router to forward network messages addressed to an IP address in the range of 10.0.0.1 through 10.0.0.50 to the cloud edge router. The forwarded network message could then be routed to the corresponding cloud VPC resource 135 (e.g., by the cloud edge router).

Similarly, the cloud automation component 140 may configure cloud network devices in order to associate the cloud VPC resources 135 with the virtual private cloud. For example, the cloud automation component 140 could configure a cloud edge router to forward network messages sent to particular network addresses to an enterprise edge router. The enterprise edge router could then forward the network messages to a corresponding enterprise VPC resource 115. Once both the enterprise network device(s) and the cloud network device(s) are configured, the enterprise VPC resources 115 and cloud VPC resources 135 can be said to be within the same virtual private cloud, such that applications running on the enterprise VPC resources 115 can communicate with applications running on the cloud VPC resources 135 (and vice versa) as if they were connected to the same intranetwork. Furthermore, it is transparent to applications running on the enterprise VPC resources 115 that the cloud VPC resources 135 are not actually connected to the same local network.

Additionally, the enterprise automation component 120 may configure the enterprise network devices to use one or more filters, such that only certain network messages sent to the range of network addresses will be forwarded to the cloud network device. For example, in an embodiment where only a subset of resources in the enterprise environment 110 are to be associated with the VPC, the enterprise automation component 120 could configure an enterprise edge router to only forward network messages from network addresses belonging to one of the enterprise VPC resources 115 to the cloud edge router. Similarly, since the cloud environment 130 will almost certainly include resources not associated with the virtual private cloud, the cloud automation component 140 may configure the cloud edge router to only forward network messages from network addresses belonging to one of the cloud VPC resources 135 to the enterprise edge router. Advantageously, doing so enables multiple separate virtual private clouds to exist within the enterprise environment 110 and the cloud environment 130.

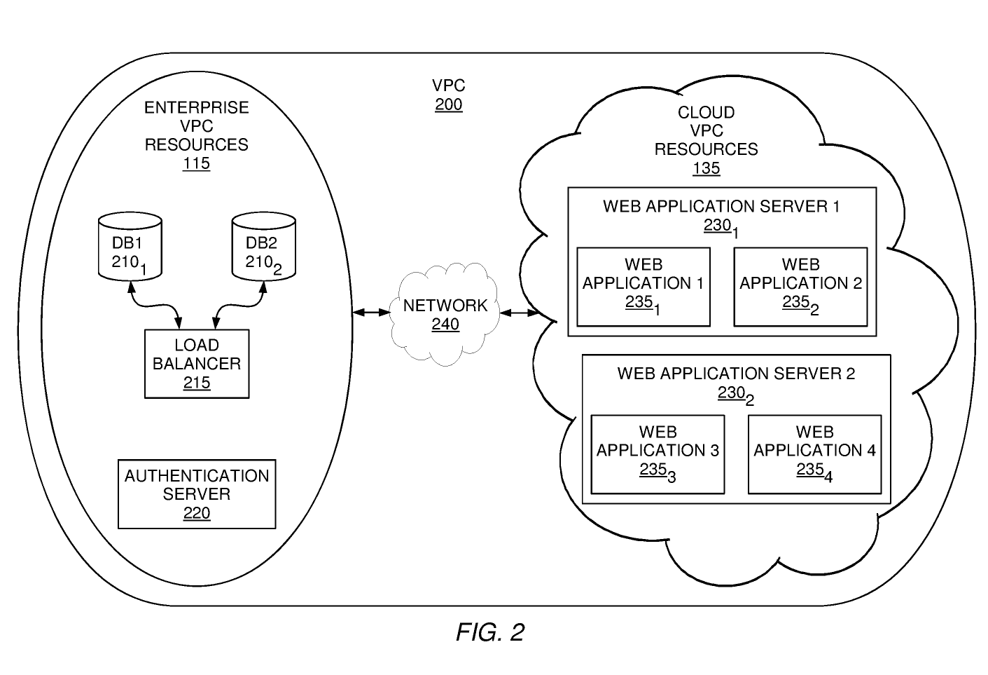

As an additional advantage, the use of a virtual private cloud allows the enterprise to effectively expand their computing infrastructure into the cloud. Furthermore, by using the enterprise automation component 120 and the cloud automation component 140, the provisioning and configuration of various computing resources may be performed automatically, resulting in a more efficient expansion process. Furthermore, the enterprise may make such an expansion while taking advantage of their existing computing infrastructure. An example of such an expansion is shown in FIG. 2, which is a block diagram illustrating a virtual private cloud, according to one embodiment of the present disclosure. As shown, the virtual private cloud 200 includes both enterprise VPC resources 115 and cloud VPC resources 135 interconnected via a network 240. In the present example, the enterprise VPC resources 115 include databases 210₁ and 210₂, connected to a load balancer 215, and an authentication server 220. The cloud VPC resources 135, in turn, contain two web application servers 230, each hosting respective web applications 235. Of note, it is contemplated that the depicted applications (i.e., the databases 210, the load balancer 215, the authentication server 220 and the web application servers 230) may be hosted on any number of computing systems within their respective environments. For example, the authentication server 220 could be hosted on the same computing system as the load balancer 215, while each of the databases 210 could be distributed across multiple computing systems.

As discussed above, once associated with the same virtual private cloud 200, applications on the enterprise VPC resources 115 and the cloud VPC resources 135 may communicate with applications on the other set of resources as if connected via an intranetwork. This, in turn, allows the enterprise to expand their network into the cloud, while still using components of their existing computing infrastructure. For instance, in the depicted example, the enterprise has deployed several web application servers 230 and web applications 235 into the cloud. However, because the enterprise VPC resources 115 and cloud VPC resources 135 are part of the same VPC, the web application server 1 230₁ may access enterprise resources such as the databases 210 and the authentication server 220. Advantageously, this allows the enterprise to re-use particular components of their computing infrastructure (e.g., the authentication server 220), rather than having to deploy a second instance of the authentication server into the cloud. As a further advantage, the enterprise may not wish to deploy particularly sensitive applications and data into the cloud (e.g., the databases 210) due to security concerns. However, by associating the resources with the VPC 200, the enterprise may maintain this sensitive information locally, while still allowing other applications deployed into the cloud to seamlessly access this information.

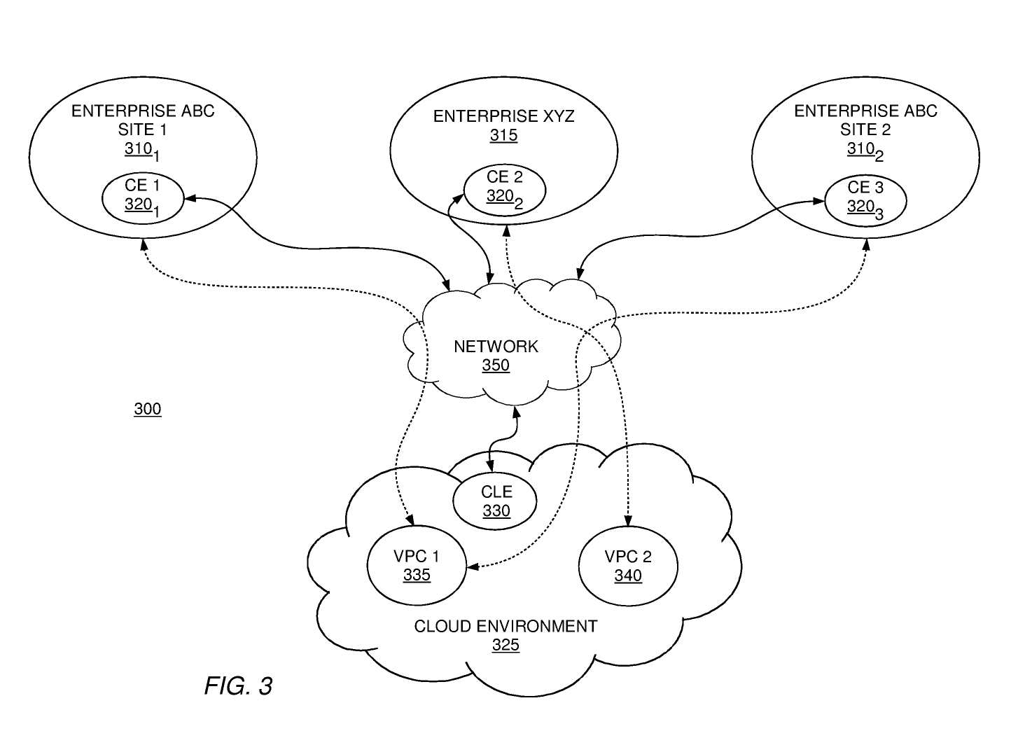

Additionally, as discussed above, embodiments may use filters to ensure that only network messages from particular resources are included in a virtual private cloud. One advantage resulting from the use of such filters is that the cloud provider may host multiple virtual private clouds for different clients. An example of this is shown in FIG. 3, which is a block diagram illustrating a network environment configured to host multiple virtual private clouds, according to one embodiment of the present disclosure. As shown, the environment 300 includes two sites for enterprise ABC 310₁ and 310₂, as well as a site for enterprise XYZ 315. Each enterprise 310 and 315 also contains a respective client edge router 320. The enterprises 310 and 315 are connected to a cloud environment 325 via a network 350. The cloud environment 325 contains a cloud edge router 330, VPC 1 335 and VPC 2 340. For purposes of this example, assume that the network 350 represents an internetwork (e.g., the Internet).

As discussed above, an enterprise automation component 120 may configure enterprise network devices in order to associate particular enterprise resources with a virtual private cloud. For example, an enterprise automation component 120 for the enterprise ABC sites 310₁ and 310₂ could configure the client edge router 320₁ and 320₃, respectively, to associate particular enterprise resources with the VPC 1 335. Such configuration may include creating forwarding rules which forward network messages sent to particular network addresses to a network device for the cloud, such as the cloud edge router 330. Additionally, such configuration may also include the creation of filters so that only network messages received from particular resources at the enterprise ABC site 1 310₁ are forwarded. Furthermore, in the depicted example, the enterprise XYZ 315 is associated with the VPC 2 340. Likewise, an enterprise automation component 120 for the enterprise XYZ 315 could configure the client edge router 320 to forward particular network messages to the cloud edge router 330, so that those network messages may be forwarded on to corresponding computing resources in the VPC 2 340.

In the depicted example, such filters have been used to create virtual private clouds 335 and 340 which exist side-by-side within the cloud environment 325. However, as indicated by the hash lines, the VPC 2 340 is associated with enterprise XYZ 315 while the VPC 1 335 is associate with enterprise ABC 310. As a result, enterprise resources at the enterprise XYZ 315 will be able to communicate with cloud resources associated with the VPC 2 340 as if they were connected via an intranetwork, but may be unable to communicate with the cloud resources associated with the VPC 1 335 at all. Likewise, the enterprises resources for the enterprise ABC site 1 310₁ and enterprise ABC site 2 310₂ may communicate with the cloud resources associated with the VPC 1, as if connected via an intranetwork. However, the enterprise ABC resources may be unable to communicate at all with the cloud resources associated with VPC 2 340, as they are not part of the same virtual private cloud. Advantageously, doing so enables the cloud provider to securely host multiple virtual private clouds for different clients (or multiple virtual provide clouds for a single client).

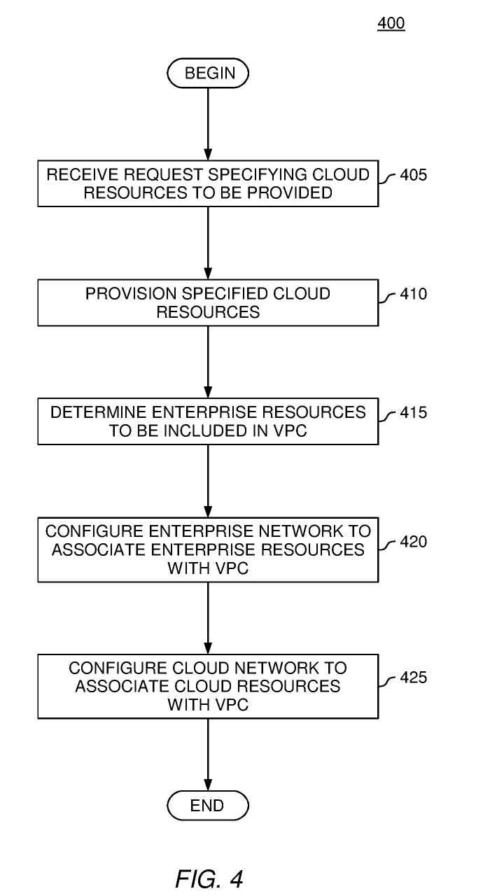

FIG. 4 is a flow diagram illustrating a method for creating a virtual private cloud, according to one embodiment of the present disclosure. As shown, the method 400 begins at step 405, where a VPC provisioning component 145 receives a request specifying cloud resources to be provided. As discussed above, such cloud resources may include hardware and/or software resources in the cloud to be included in a virtual private cloud. As an example, a request could specify that 5 computer systems (e.g., virtual machines), each with 4 processors and 8 GB of memory, should be provisioned and included in the virtual private cloud. Such a request may further specify configuration parameters for use in configuring the cloud resources. Continuing the above example, the request could specify a range (or multiple ranges) of IP addresses for use by the provisioned computer systems. Additionally, the request may include configuration information specifying a network topology for the provisioned cloud resources, which describes how the cloud resources should be arranged with respect to one another. For example, the request could specify that a load balancer should be provided and used to distribute requests amongst the provisioned virtual machines in a round-robin fashion. Of course, such examples are without limitation and for illustrative purposes only. Moreover, one of ordinary skill in the art will recognize that any number of other types of computing resources, with numerous other configurations and arrangements, may be used in accordance with various embodiments.

Upon receiving the request, the VPC provisioning component 145 provisions the specified cloud resources (step 410). Such provisioning may include instantiating the resources in the cloud (e.g., creating the virtual machines) as well as configuration the resources in the cloud (e.g., setting the IP address and network configuration information for the created virtual machines). Of note, the cloud resources could be instantiated using physical resources at a single data center or could be instantiated across multiple data centers providing resources to the cloud.

Additionally, an enterprise automation component 120 determines a set of enterprise resources to be included in the virtual private cloud (step 415). Similar to the cloud resources, the enterprise resources include hardware and/or software computing resources. However, unlike the cloud resources which are resources provided at one or more data centers in the cloud, the set of enterprise resources includes resources that are managed by the enterprise creating the virtual private cloud. For example, the enterprise resources could be computing resources that are physically present at a site of the enterprise and are interconnected using the enterprise's local area network.

Once the enterprise resources are identified, the enterprise automation component 120 configures one or more enterprise network devices to associate the first set of enterprise resources with the virtual private cloud (step 420). Such configuration may include creating forwarding rules on a network device (e.g., an enterprise edge router) for the enterprise that forward network messages sent to particular IP addresses to a cloud edge device (e.g., a cloud edge router). The enterprise automation component 120 may also create one or more filters on the device, so that the forwarding rules only apply to network messages received from a particular set of enterprise resources that are associated with the virtual private cloud. Similarly, a cloud automation component 140 configures a cloud network device (e.g., a cloud edge router) to associate the instantiated cloud resources with the virtual private cloud (step 425). Once the cloud network device(s) are configured, the method 400 ends.

As an example of instantiating a virtual private cloud according to the method 400, an enterprise may wish to associate enterprise resources with IP addresses 192.168.1.1 through 192.168.1.100 with the virtual private cloud. Of note, while this range of IP addresses could include all the computing resources managed by the enterprise, this is not necessarily the case. Rather, it is explicitly contemplated that the enterprise could define only a subset of the enterprise resources for association with the virtual private cloud. Additionally, the enterprise may wish to assign IP addresses 192.168.1.101 through 192.168.1.150 to the cloud resources associated with the virtual private cloud. In such a scenario, the enterprise may reserve IP addresses in the range of 192.168.1.101 through 192.168.1.150, so that no enterprise resources may use these IP addresses and submit a request to a VPC provisioning component 145 specifying cloud resources to be instantiated and configuration parameters specifying that the cloud resources should be assigned IP addresses in the range of 192.168.1.101 through 192.168.1.150.

Continuing the example, the enterprise automation component 120 could configure an enterprise edge router to forward network messages addressed to IP addresses in the range of 192.168.1.101 through 192.168.1.150 and received from IP addresses in the range of 192.168.1.1 through 192.168.1.100 to a cloud edge router for the cloud. The cloud edge router could also be configured (e.g., by the cloud automation component 140) to receive the forwarded network messages from the enterprise edge router and to transmit the network messages to the corresponding cloud resource. Likewise, a cloud automation component 140 could configure a cloud edge router to forward network messages addressed to IP addresses in the range of 192.168.1.1 through 192.168.1.100 and received from IP addresses in the range of 192.168.1.101 through 192.168.1.150 to an enterprise edge router for the enterprise. The enterprise edge router could further be configured (e.g., by the enterprise automation component 120) to receive these forwarded network messages from the cloud edge router and to transmit the network messages to the corresponding enterprise resource. Advantageously, doing so enables applications running on the enterprise resources to communicate with applications running on the cloud resources (and vice versa), as if enterprise resources and the cloud resources were on the same intranetwork. As a result of this, the enterprise may effectively expand their network into the cloud as needed, while such an expansion remains transparent to applications themselves.

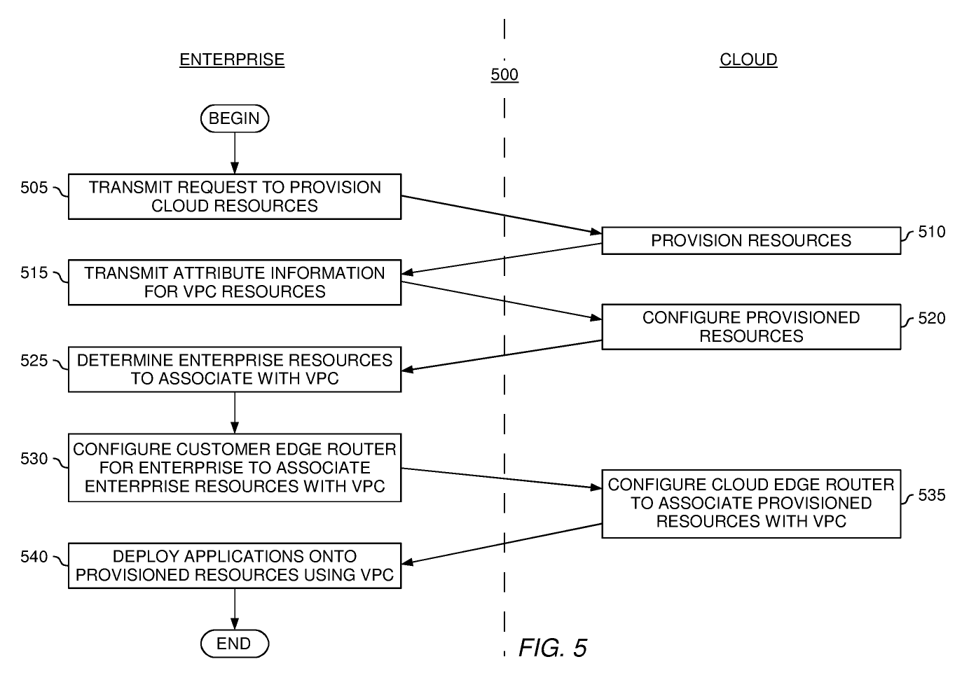

FIG. 5 is a flow diagram illustrating a method for creating a virtual private cloud, according to one embodiment of the present disclosure. As shown, the method 500 begins at step 505, where an enterprise automation component 120 transmits a request specifying cloud resources to be provisioned to a VPC provisioning component 145. In one embodiment, the resources to be provisioned are determined based on input received from a user of the enterprise automation component 120 (e.g., via a user interface). Upon receiving the request, the VPC provisioning component 145 provisions the specified resources (step 510).

In the depicted example, the enterprise automation component 120 then transmits attribute information for the cloud resources associated with the virtual private cloud to the cloud automation component 140 (step 515). Such attribute information includes configuration parameters for use in configuring the provisioned cloud resources. For instance, a user could specify (e.g., using a user interface) a range of IP addresses to assign to the cloud resources and the enterprise automation component 120 could transmit this information to the cloud automation component 140. Additionally, as discussed above, the enterprise automation component 120 could be configured to determine existing configuration information for the enterprise resources. The enterprise automation component could transmit this information to the cloud automation component 140.

Upon receiving the configuration information, the cloud automation component 140 configures the provisioned cloud resources (step 520). For example, where the configuration information specifies a range of IP addresses for use by the cloud resources, the cloud automation component 140 could configure the cloud resources to each use a respective one of the IP addresses in the range of IP addresses. Likewise, where the configuration information specifies a network security protocol for use by the cloud resources (e.g., IPsec), the cloud automation component 140 could configure the cloud resources to use the specified network security protocol.

The enterprise automation component 120 then configures a customer edge router for the enterprise to associate a set of enterprise resources with the virtual private cloud (step 530). That is, the enterprise automation component 120 configures the customer edge router to forward network messages sent to certain IP addresses (e.g., to IP addresses assigned to the cloud resources on the cloud intranetwork) to a cloud edge router. The cloud edge router could then transmit the forwarded network messages to a corresponding cloud resource associated with the IP address to which the network message was originally sent. Additionally, as discussed above, the enterprise automation component 120 may configure the customer edge router to only perform such forwarding operations when the network messages are sent from one of the enterprise resources associated with the virtual private cloud.

Similarly, the cloud automation component 140 configures a cloud edge router to associate the provisioned cloud resources with the virtual private cloud (step 535). For instance, the cloud automation component 140 could configure a cloud edge router to forward network messages sent to particular IP addresses (e.g., an IP address of a first enterprise resource on the enterprise intranet) to the customer edge router for the enterprise. The customer edge router could then transmit the network messages to a corresponding enterprise resource (e.g., to the first enterprise resource). Once the cloud resources are provisioned and the network devices are configured, the enterprise automation component 120 then deploys applications and associated data onto the provisioned cloud resources as if the enterprise resources and cloud resources were on the same intranetwork (step 540). Once the applications and data are deployed, the method 500 ends.

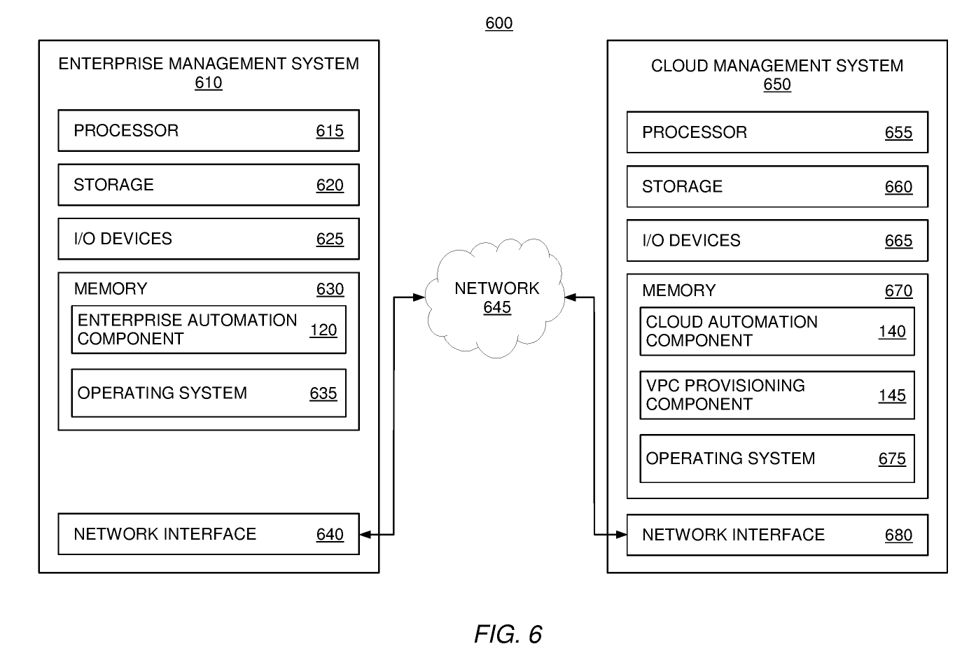

FIG. 6 is a block diagram illustrating a network environment configured to a virtual private cloud, according to one embodiment of the present disclosure. As shown, an enterprise management system 610 and a cloud management system 650 are interconnected via a network 645. In various embodiments, the systems 610 and 650 may include existing computer systems, e.g., desktop computers, server computers, network devices (e.g., routers), laptop computers, tablet computers and the like. The systems 610 and 650 illustrated in FIG. 6, however, are merely examples of computer systems in which embodiments may be used. More generally, however, embodiments may be implemented differently, regardless of whether the computer systems are complex multi-user computing systems, such as a cluster of individual computers connected by a high-speed network, single-user workstations or network appliances lacking non-volatile storage.

Returning to the depicted example, the enterprise management system 610 includes a processor 615, which obtains instructions and data via a bus from a memory 630 and storage 620. Processor 615 is a programmable logic device that performs instruction, logic and mathematical processing, and may be representative of one or more CPUs. Storage 620 is representative of hard-disk drives, flash memory devices, optical media and the like. Generally, the storage 620 stores application programs and data for use by the enterprise management system 610. The enterprise management system 610 is operably connected to the network 645 via the network interface 640.

The memory 630 is any memory sufficiently large to hold the necessary programs and data structures. Memory 630 could be one or a combination of memory devices, including Random Access Memory, nonvolatile or backup memory (e.g., programmable or Flash memories, read-only memories, etc.). In addition, memory 630 and storage 620 may be considered to include memory physically located elsewhere; for example, on another computer coupled to the enterprise management system 610 via a data bus. The memory 630 includes an enterprise automation component 120 and an operating system (OS) 635. Operating system 635 is software used for managing the operation of the enterprise management system 610. Examples of OS 635 include UNIX, versions of the Microsoft Windows® operating system and distributions of the Linux® operating system. Additionally, OS 635 may be an operating system specially developed for network devices, such as Cisco IOS®.

Similarly, the cloud management system 650 includes a processor 655, which obtains instructions and data via a bus from a memory 670 and storage 660. Processor 655 is a programmable logic device that performs instruction, logic and mathematical processing, and may be representative of one or more CPUs. Storage 660 is representative of hard-disk drives, flash memory devices, optical media and the like. Generally, the storage 660 stores application programs and data for use by the cloud management system 650. The cloud management system 650 is operably connected to the network 645 via the network interface 680.

The memory 670 is any memory sufficiently large to hold the necessary programs and data structures. Memory 670 could be one or a combination of memory devices, including Random Access Memory, nonvolatile or backup memory (e.g., programmable or Flash memories, read-only memories, etc.). In addition, memory 670 and storage 660 may be considered to include memory physically located elsewhere; for example, on another computer coupled to the cloud management system 650 via a data bus. The memory 670 includes a cloud automation component 140, a VPC provisioning component 145 and an operating system (OS) 675. Operating system 675 is software used for managing the operation of the cloud management system 650. Examples of OS 675 include UNIX, versions of the Microsoft Windows® operating system and distributions of the Linux® operating system. Additionally, OS 675 may be an operating system specially developed for network devices, such as Cisco IOS®.

As discussed above, the enterprise automation component 120 generally configures enterprise computing resources and enterprise network devices to create a virtual private cloud. For example, the enterprise automation component 120 could configure an enterprise edge network device (e.g., an edge router) to forward network messages directed towards a particular set of network addresses to a cloud network device (e.g., a cloud edge router). As discussed above, the enterprise automation component 120 could be further configured to only forward network messages coming from a subset of enterprise computing resources. For instance, such a subset could be specified using a range of network addresses for the enterprise computing resources.

Additionally, the cloud automation component 140 generally configures cloud resources for inclusion in the virtual private cloud. For example, the cloud automation component 140 could configure a cloud edge network device (e.g., an edge router) to forward network messages directed to a particular set of network addresses to the enterprise edge network device. Similarly, the cloud automation component 140 could further configure the cloud edge network device to only forward network messages from certain cloud resources. For example, the cloud automation component 140 could configure the cloud edge network device to only forward network messages from the particular cloud resources that are included in the virtual private cloud. The particular cloud resources could be specified using, for example, a range of network addresses associated with the cloud resources.

As will be appreciated by one skilled in the art, embodiments presented in this disclosure may be implemented as a system, method or computer program product. Accordingly, embodiments presented herein may be implemented as an entirely hardware embodiment, as an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments may be devised without departing from the basic scope thereof. In view of the foregoing, the scope of the present disclosure is determined by the claims that follow.

We claim:

1. A method for providing a virtual private cloud, comprising:
receiving a request to integrate enterprise computing resources with cloud-based computing resources in a virtual private cloud, wherein resources within the virtual private cloud are communicatively coupled at a common logical network level;
responsive to the request, issuing one or more network communications to a cloud provider hosting the cloud-based computing resources, wherein the one or more network communications configure the cloud provider to provision a cloud-based network device to forward network packets addressed to network addresses from any of a specified plurality of network addresses between the enterprise computing resources and the cloud-based computing resources;
integrating the enterprise computing resources into the virtual private cloud by configuring the enterprise network device to forward network packets addressed to network addresses from any of the specified plurality of network addresses between the enterprise computing resources and the cloud-based computing resources, wherein the enterprise network device is configured to send network packets received from enterprise computing resources and sent to network addresses associated with the cloud-based computing resources to the cloud-based network device, and to send network packets received from the cloud-based network device to corresponding enterprise computing resources; and
forwarding network packets between applications running on the enterprise computing resources and applications running on the cloud-based computing resources over the common logical network provided by the virtual private cloud.

2. The method of claim 1, wherein the one or more network communications further configure the cloud provider to configure the cloud-based network device to send network packets received from the cloud-based computing resources to an enterprise network device and to send network packets received from the enterprise network device to corresponding cloud-based computing resources.

3. The method of claim 1, wherein the cloud network device is configured to only send network packets received from cloud resources associated with one of a plurality of network addresses to the enterprise network device.

4. The method of claim 1, wherein the enterprise network device is configured to only send network packets received from a subset of enterprise computing resources to the cloud network device.

5. The method of claim 1, further comprising:
determining configuration information for integrating the requested cloud-based computing resources with the enterprise computing resources, wherein the determined configuration information includes at least one of network addresses, a network address range, network configuration information or enterprise network configuration information.

6. The method of claim 5, wherein determining the configuration information for integrating the requested cloud-based computing resources with the enterprise computing resources, is further based on a current configuration of the enterprise computing resources, and further comprising:
provisioning the cloud-based computing resources, based on the determined configuration information.

7. A computer program product for providing a virtual private cloud, comprising:
computer code to receive a request to integrate enterprise computing resources with cloud-based computing resources in a virtual private cloud, wherein resources within the virtual private cloud are communicatively coupled at a common logical network level;
computer code to, responsive to the request, issue one or more network communications to a cloud provider hosting the cloud-based computing resources, wherein the one or more network communications configure the cloud provider to provision a cloud-based network device to forward network packets addressed to network addresses from any of a specified plurality of network addresses between the enterprise computing resources and the cloud-based computing resources;
computer code to integrate the enterprise computing resources into the virtual private cloud by configuring the enterprise network device to forward network packets addressed to network addresses from any of the specified plurality of network addresses between the enterprise computing resources and the cloud-based computing resources, wherein the enterprise network device is configured to send network packets received from enterprise computing resources and sent to network addresses associated with the cloud-based computing resources to the cloud-based network device, and to send network packets received from the cloud-based network device to corresponding enterprise computing resources;
computer code to forward network packets between applications running on the enterprise computing resources and applications running on the cloud-based computing resources over the common logical network provided by the virtual private cloud; and
a computer readable medium that stores the computer codes.

8. The computer program product of claim 7, wherein the one or more network communications further configure the cloud provider to configure the cloud-based network device to send network packets received from the cloud-based computing resources to an enterprise network device and to send network packets received from the enterprise network device to corresponding cloud-based computing resources.

9. The computer program product of claim 7, wherein the cloud network device is configured to only send network packets received from cloud resources associated with one of a plurality of network addresses to the enterprise network device.

10. The computer program product of claim 7, wherein the enterprise network device is configured to only send network packets received from a subset of enterprise computing resources to the cloud network device.

11. The computer program product of claim 7, further comprising:
computer code to determine configuration information for integrating the requested cloud-based computing resources with the enterprise computing resources, wherein the determined configuration information includes at least one of network addresses, a network address range, network configuration information or enterprise network configuration information.

12. The computer program product of claim 11, wherein the computer code to determine the configuration information for integrating the requested cloud-based computing resources with the enterprise computing resources, is further based on a current configuration of the enterprise computing resources, and further comprising:
computer code to provision the cloud-based computing resources, based on the determined configuration information.

13. A system, comprising:
a processor; and
a memory to store executable code, which, when executed on the processor, performs a method for providing a virtual private cloud, comprising:
receiving a request to integrate enterprise computing resources with cloud-based computing resources in a virtual private cloud, wherein resources within the virtual private cloud are communicatively coupled at a common logical network level;
responsive to the request, issuing one or more network communications to a cloud provider hosting the cloud-based computing resources, wherein the one or more network communications configure the cloud provider to provision a cloud-based network device to forward network packets addressed to network addresses from any of a specified plurality of network addresses between the enterprise computing resources and the cloud-based computing resources;
integrating the enterprise computing resources into the virtual private cloud by configuring the enterprise network device to forward network packets addressed to network addresses from any of the specified plurality of network addresses between the enterprise computing resources and the cloud-based computing resources, wherein the enterprise network device is configured to send network packets received from enterprise computing resources and sent to network addresses associated with the cloud-based computing resources to the cloud-based network device, and to send network packets received from the cloud-based network device to corresponding enterprise computing resources; and
forwarding network packets between applications running on the enterprise computing resources and applications running on the cloud-based computing resources over the common logical network provided by the virtual private cloud.

14. The system of claim 13, wherein the one or more network communications further configure the cloud provider to configure the cloud-based network device to send network packets received from the cloud-based computing resources to an enterprise network device and to send network packets received from the enterprise network device to corresponding cloud-based computing resources.

15. The system of claim 13, wherein the cloud network device is configured to only send network packets received from cloud resources associated with one of a plurality of network addresses to the enterprise network device.

16. The system of claim 13, wherein the enterprise network device is configured to only send network packets received from a subset of enterprise computing resources to the cloud network device.

17. The system of claim 13, the method further comprising:
determining configuration information for integrating the requested cloud-based computing resources with the enterprise computing resources, wherein the determined configuration information includes at least one of network addresses, a network address range, network configuration information or enterprise network configuration information.

18. The system of claim 17, wherein determining the configuration information for integrating the requested cloud-based computing resources with the enterprise computing resources, is further based on a current configuration of the enterprise computing resources, and the method further comprising:
provisioning the cloud-based computing resources, based on the determined configuration information.

19. A method for instantiating a virtual private cloud containing cloud resources and client resources, comprising:
receiving a request specifying cloud resources to be included in the virtual private cloud;
provisioning the cloud resources specified in the request; and
configuring at least one cloud network device to associate the cloud resources with the virtual private cloud, whereby applications running on the cloud resources can interact with applications running on the client resources on a common logical network level.

20. The method of claim 19, wherein the request further specifies one or more configuration parameters for the cloud resources.

21. The method of claim 20, wherein the one or more configuration parameters include at least one of one or more network addresses, a network address range, network configuration information and client network configuration information.

22. The method of claim 20, wherein provisioning the cloud resources specified in the request further comprises:
configuring at least one of the cloud resources based on the configuration parameters specified in the request.

23. The method of claim 19, wherein configuring at least one cloud network device further comprises:
determining a plurality of network addresses associated with the client resources; and
configuring the at least one cloud network device to transmit a network message sent to a first network address of the plurality of network addresses and received from one of the provisioned cloud resources to a client network device, wherein the client network device is configured to transmit the network message to a respective client resource associated with the first network address.

24. The method of claim 23, wherein the at least one cloud network device includes a cloud edge router and wherein the client network device comprises a client edge router.

25. The method of claim 23, wherein the cloud network device is further configured to forward network traffic coming from cloud resources having a second set of network addresses, wherein the second set of network addresses are associated with the provisioned cloud resources.
